(19) United States
(12) Patent Application Publication
(10) Pub. No.: US 2026/0101258 A1
(43) Pub. Date: Apr. 9, 2026

(54) METHODS, ARCHITECTURES, APPARATUSES AND SYSTEMS FOR ENABLING TERMINAL MOBILITY IN SINGLE DOMAIN RELIABLE AND AVAILABLE NETWORKS

(71) Applicant: InterDigital Patent Holdings, Inc., Wilmington, DE (US)

(72) Inventors: Carlos Jesus Bernardos, Madrid (ES); Alain Mourad, Ascot (GB); Filipe Conceicao, London (GB)

(21) Appl. No.: 19/116,170

(22) PCT Filed: Sep. 29, 2023
(86) PCT No.: PCT/US2023/034114

§ 371 Date: Mar. 27, 2025

Related U.S. Application Data
(60) Provisional application No. 63/411,851, filed on Sep. 30, 2022.

(51) Int. Cl. H04W 36/26; H04W 36/08

(52) U.S. Cl. CPC H04W 36/26; H04W 36/08

(57) ABSTRACT

Procedures, methods, architectures, apparatuses, systems, devices, and computer program products enabling, supporting and/or improving terminal mobility in reliable and available wireless (RAW) networks are described. One method may include receiving, by a target RAW network node, a message to initiate a RAW handover of a WTRU from a current RAW network node that the WTRU is attached to. The message may include information including at least one of: an ID of the WTRU, an ID of the current RAW network node the WTRU is attached to, an ID of a RAW domain that the current RAW network node belongs to, and/or a description of QoS parameters required by a flow between the WTRU and an external node. The method may include determining, based at least on the information provided in the message, tracks and subtracks for supporting a QoS of the flow between the WTRU and the external node, and sending, to the current RAW network node, an acknowledgement message with an ID of the WTRU and/or description of the QoS parameters that can be granted to the flow.

### CROSS-REFERENCE TO RELATED APPLICATIONS

This application claims the benefit of U.S. Provisional Patent Application No. 63/411,851, filed Sep. 30, 2022; the contents of this application is incorporated herein by reference in its entirety.

### FIELD

The present disclosure is generally directed to the fields of communications, software and/or encoding, including, for example, to methods, architectures, apparatuses, systems related to enabling, supporting and/or improving terminal mobility.

### SUMMARY

An embodiment may be directed to a method that may be implemented by a wireless transmit/receive unit (WTRU). The method may include determining that a reliable and available wireless (RAW) handover of the WTRU is imminent and, based on the determination that the RAW handover of the WTRU is imminent, sending first information to a RAW network node that the WTRU is currently attached to. The first information may indicate (i) quality of service (QoS) parameters required during and after the RAW handover by a flow between the WTRU and an external node, (ii) whether bicasting is requested, and (iii) any of: an identifier of the WTRU, an identifier of a target RAW network node that the WTRU wants to attach to, and/or an identifier of a RAW domain that the target RAW network node belongs to. The method may include receiving second information indicating that the WTRU is permitted to perform the RAW handover. The second information may include an indication of a granted QoS for the flow and the identifier of the target RAW network node that the WTRU should attach to. The method may include performing the handover to attach to the target RAW network node.

An embodiment may be directed to a wireless transmit/receive unit (WTRU) including circuitry, which may include any of a transmitter, receiver, processor and/or memory. The circuitry may be configured to determine that a reliable and available wireless (RAW) handover of the WTRU is imminent and, based on the determination that the RAW handover of the WTRU is imminent, to send first information to a RAW network node that the WTRU is currently attached to. The first information may indicate (i) quality of service (QoS) parameters required during and after the RAW handover by a flow between the WTRU and an external node, (ii) whether bicasting is requested, and (iii) any of: an identifier of the WTRU, an identifier of a target RAW network node that the WTRU wants to attach to, and/or an identifier of a RAW domain that the target RAW network node belongs to. The circuitry may be configured to receive second information indicating that the WTRU is permitted to perform the RAW handover. The second information may include an indication of a granted QoS for the flow and the identifier of the target RAW network node that the WTRU should attach to. The circuitry may be further configured to perform the handover to attach to the target RAW network node.

An embodiment may be directed to a method that may be implemented by a network node such as a target reliable and available wireless (RAW) network node. The method may include receiving a message to initiate a RAW handover of a wireless transmit/receive unit (WTRU) from a current RAW network node that the WTRU is attached to. The message may be received from the current RAW network node, and the message may include information including any of: an identifier of the WTRU, an identifier of the current RAW network node that the WTRU is attached to, an identifier of a RAW domain that the current RAW network node belongs to, and/or a description of quality of service (QoS) parameters required by a flow between the WTRU and an external node. The method may include determining, based at least on the information provided in the message, tracks and subtracks for supporting a QoS of the flow between the WTRU and the external node. The method may include sending, to the current RAW network node, an acknowledgement message comprising at least one of an identifier of the WTRU and a description of the QoS parameters that can be granted to the flow.

An embodiment may be directed to an apparatus including circuitry, which may include any of a transmitter, receiver, processor and/or memory. The circuitry may be configured to receive a message to initiate a RAW handover of a wireless transmit/receive unit (WTRU) from a current RAW network node to which the WTRU is attached to the apparatus. The message may be received from the current RAW network node, and the message may include information including any of: an identifier of the WTRU, an identifier of the current RAW network node that the WTRU is attached to, an identifier of a RAW domain that the current RAW network node belongs to, and/or a description of quality of service (QoS) parameters required by a flow between the WTRU and an external node. The circuitry may be configured to determine, based at least on the information provided in the message, tracks and subtracks for supporting a QoS of the flow between the WTRU and the external node. The circuitry may be configured to send, to the current RAW network node, an acknowledgement message comprising at least one of an identifier of the WTRU and a description of the QoS parameters that can be granted to the flow.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an example diagram of a system for communication involving a reliable and available wireless (RAW) domain, according to one example embodiment;

FIG. 3 is an example diagram depicting control plane signaling for UE-controlled RAW enabled mobility, according to some embodiments;

FIG. 4 is an example diagram depicting control plane signaling for network-controlled RAW enabled mobility, according to some embodiments;

FIG. 5 is an example of the format of the message data field in the Mobility Header, according to an embodiment;

FIG. 6 is an example of the format of the Message Data field in the Mobility Header, according to some embodiments;

FIG. 7 is an example format of a RAW_ID mobility option, according to some embodiments;

FIG. 8 is an example format of a PoA_ID mobility option, according to some embodiments;

FIG. 9 is an example format for a RAW QoS mobility option, according to an embodiment;

FIG. 10 is an example of a PoA ID subelement, according to an embodiment;

FIG. 11 is an example of a PSE ID subelement, according to an embodiment;

FIG. 12 illustrates an example of a RAW ID subelement, according to an embodiment;

FIG. 13 illustrates an example flowchart of a method for enabling, supporting and/or improving terminal mobility in reliable and available wireless (RAW) networks, according to some embodiments; and

FIG. 14 illustrates an example flowchart of a method for enabling, supporting and/or improving terminal mobility in reliable and available wireless (RAW) networks, according to some embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

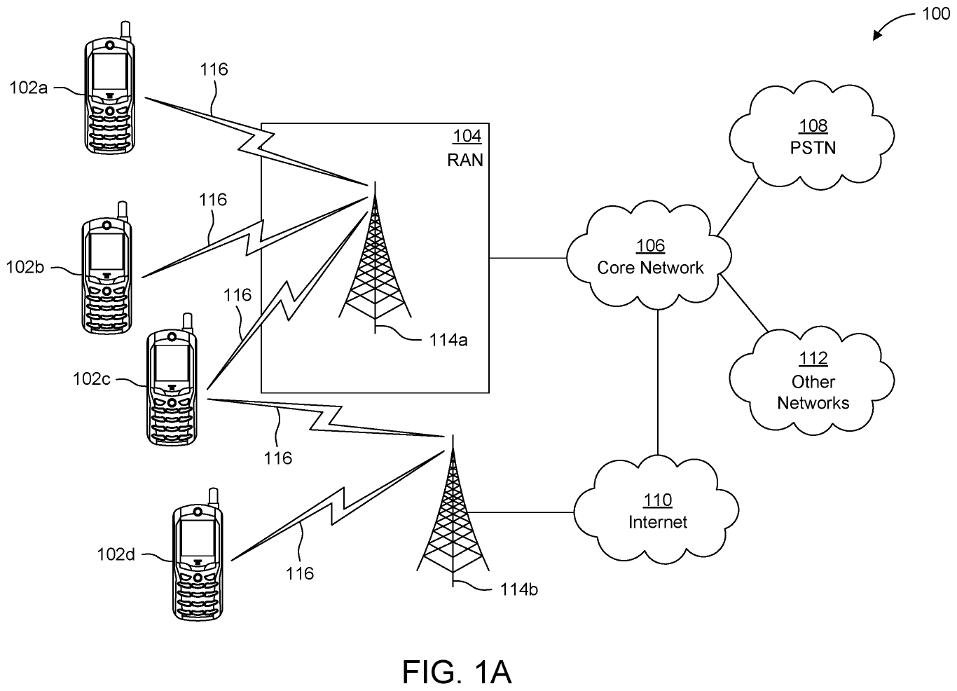

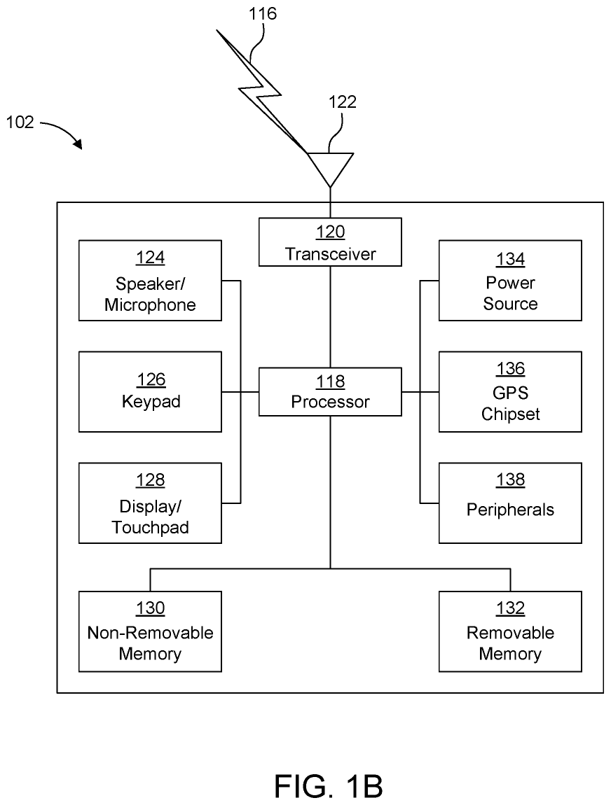

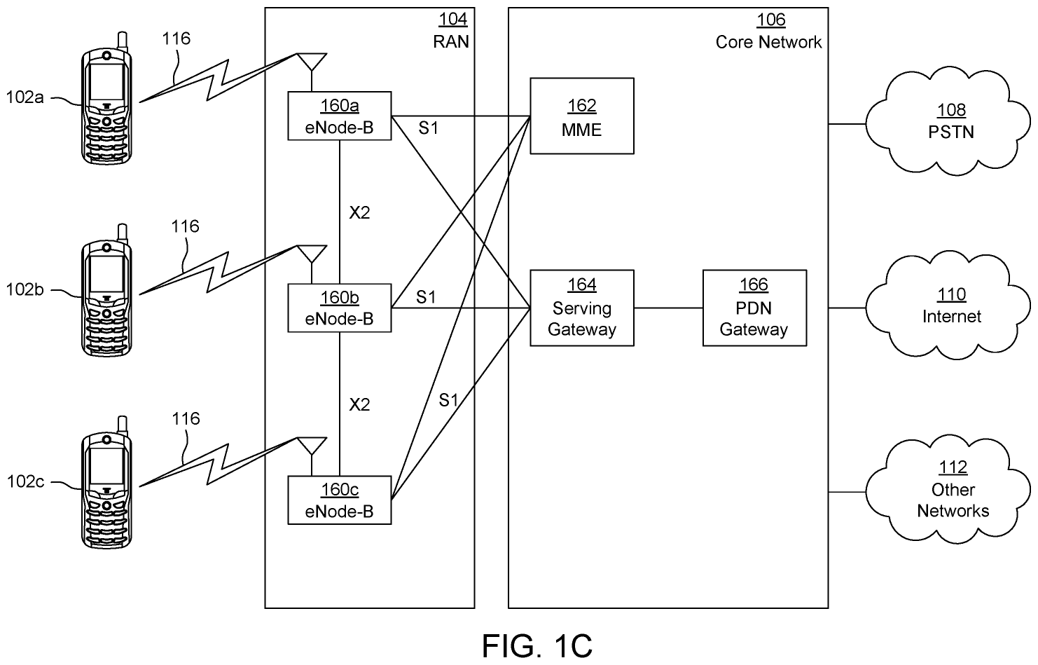

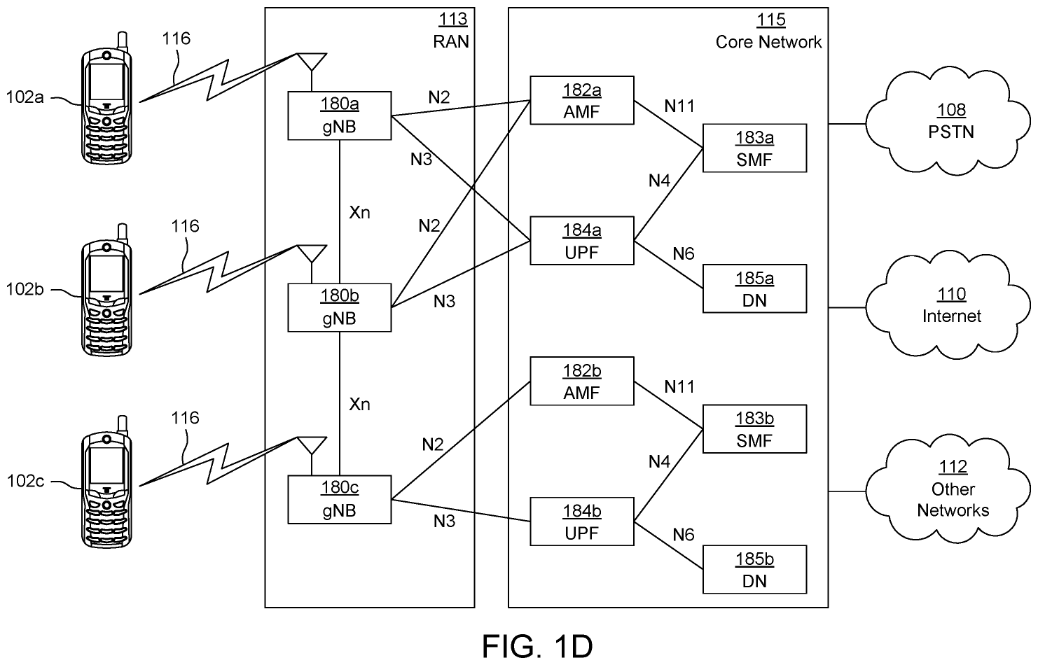

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Based on time, resource reservation, and policy enforcement by distributed shapers, Deterministic Networking provides the capability to carry specified unicast or multicast data streams for real-time applications with extremely low data loss rates and bounded latency, e.g., so as to support time-sensitive and mission-critical applications on a converged enterprise infrastructure.

Wireless operates on a shared medium, and transmissions cannot be fully deterministic due to uncontrolled interferences, including self-induced multipath fading. Internet Engineering Task Force (IETF) Reliable and Available Wireless (RAW) is an effort to provide Deterministic Networking (DetNet) along a path that includes at least one wireless element. RAW ensures high reliability and availability for internet protocol (IP) connectivity over a wireless medium. The wireless medium presents significant challenges to achieve deterministic properties such as low packet error rate, bounded consecutive losses, and bounded latency. RAW extends the IETF DetNet Working Group (WG) concepts to guarantee high reliability and availability for an IP network utilizing scheduled wireless segments and other media, e.g., frequency and/or time-sharing physical media resources with stochastic traffic: IEEE Std. 802.15.4 time slotted channel hopping (TSCH), Third Generation Partnership Project (3GPP) 5G ultra-reliable low latency communications (URLLC), IEEE 802.11ax/be, and L-band Digital Aeronautical Communications System (LDACS), etc. Similar to DetNet, RAW technologies aim at staying abstract to the radio layers underneath, addressing the Layer 3 aspects in support of applications requiring high reliability and availability.

The RAW architecture framework (e.g., see [2] P. Thubert (Ed.), “Reliable and Available Wireless Architecture/Framework,” draft-ietf-raw-architecture-04, March 2022) may include main RAW operation such as the following. RAW distinguishes between long and short forwarding time scales, where the long time scale is used for route computation and the short time scale is rather used for per-packet forwarding decisions. RAW operates within the Network Plane at the forwarding time scale on one DetNet flow over a complex path called a Track. The Track may be pre-established and installed by means outside of the scope of RAW; the track may be strict or loose depending on whether each or just a subset of the hops are observed and controlled by RAW.

The RAW architecture is structured as an OODA Loop including the following steps: Observe, Orient, Decide, Act (OODA). ‘Observe’ refers to Network Plane measurement protocols for Operations, Administration and Maintenance (OAM) observing some or all hops along a track as well as the end-to-end packet delivery. ‘Orient’ refers to controller plane elements reporting the links statistics to a Path Computation Element (PCE) in a centralized controller that computes and installs the tracks and provides meta data to orient the routing decision. ‘Decide’ refers to a runtime distributed Path Selection Engine (PSE) that decides which sub-track to use for the next packet(s) that are routed along the track. ‘Act’ refers to packet (hybrid) automatic repeat request (ARQ), replication, elimination and ordering data-plane actions that operate at the DetNet Service Layer to increase the reliability of the end-to-end transmission. The RAW architecture also covers in-situ signaling when the decision is acted upon by a node that is on the path down the track from the PSE.

The overall OODA loop optimizes the use of redundancy to achieve the required reliability and availability at the Service Level Agreement (SLA) while minimizing the use of constrained resources such as spectrum and battery.

As explained above, RAW separates the path computation time scale at which a complex path is recomputed from the path selection time scale at which the forwarding decision is taken for one or a few packets. RAW operates at the path selection time scale. The RAW problem is to decide, amongst the alternative solutions proposed by the Path Computation Element (PCE), which solution will be used for each packet to provide a reliable and available service while minimizing the waste of constrained resources. To that effect, RAW defines the PSE that is the counter-part of the PCE to perform rapid local adjustments of the forwarding tables within the diversity that the PCE has selected for the Track. The PSE enables to exploit the richer forwarding capabilities with packet (hybrid) ARQ, replication, elimination and ordering (PAREO), and scheduled transmissions at a faster time scale.

As introduced above, a track may refer to a networking graph that can be followed to transport packets with equivalent treatment; as opposed to the definition of a path above, a “track” is not necessarily linear. A track may contain multiple paths that may fork and rejoin, for instance to enable the RAW PAREO operations.

In DetNet terms, a track may have the following properties: (i) a track has one Ingress node and one Egress node, which operate as DetNet Edge nodes; (ii) a track is reversible, meaning that packets can be routed against the flow of data packets, e.g., to carry OAM measurements or control messages, back to the ingress; (iii) the vertices of the track are DetNet relay nodes that operate at the DetNet service sublayer and provide the PAREO functions; and (iv) the topological edges of the graph are serial sequences of DetNet transit nodes that operate at the DetNet forwarding sublayer.

A sub-track is a track within a track. The RAW PSE may select a sub-track on a per-packet or a per group of packets basis to provide the desired reliability for the transported flows.

The IEEE 802.11 standard defines a mechanism for an STA to request to an AP a neighbor report, which may contain information about other APs (e.g., belonging to the same extended service set or to different ones). The neighbor report request may be sent to an AP, which returns a neighbor report containing information about known neighbor APs that are candidates for a service set transition. Neighbor reports may contain information concerning neighbor APs. This request/report pair enables a STA to gain information about the neighbors of the associated AP to be used as potential roaming candidates.

An example of the format of the Neighbor report (e.g., as defined in section 9.4.2.37 of IEEE 802.11-2016 standard) is shown in TABLE 1 below:

TABLE 1
Example neighbor report element format

| | | | | | | | |
|---|---|---|---|---|---|---|---|
| Element ID | Length | BSSID | BSSID | Operating | Channel | PHY | Optional |
| 1 octet | 1 octet | 6 octets | Information | Class | Number | Type | Subelements |
| | | | 4 octets | 1 octet | 1 octet | 1 octet | variable |
| | | | | | | | octets |

There can be several use cases (e.g., see [1] C J. Bernardos (Ed.), “RAW use cases,” RFC 9450 August 2023), where reliability and availability may be key requirements for wireless heterogeneous networks. One example is extended Reality (XR) applications, such as for example immersive gaming, digital twinning, etc. In these environments, UEs demand strict and predictable behavior, in terms of latency and/or resilience and/or availability and/or throughput, while the UEs move and might change their point of attachment.

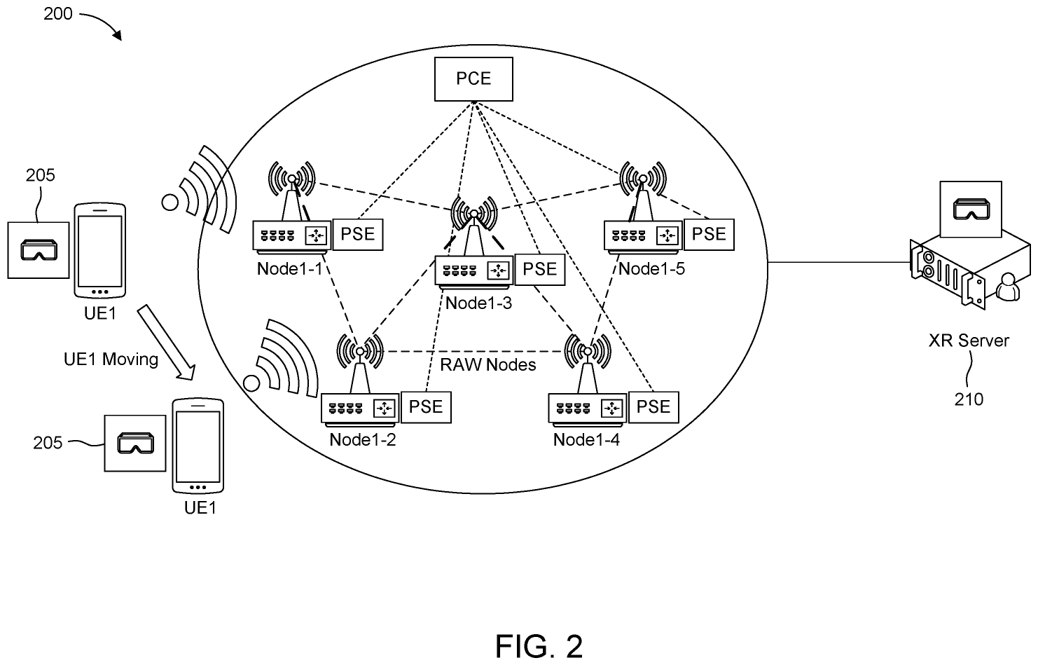

FIG. 2 illustrates an example system 200 for communication involving a RAW domain, according to an example embodiment. As shown in the example of FIG. 2, the system 200 may include one or more RAW nodes, e.g., node 1-1, node 1-2, node 1-3, node 1-4 and node 1-5. Although five RAW nodes are depicted in the example of FIG. 2, this is just for purposes of illustration and it should be understood that any number of RAW nodes may be included according to certain embodiments. In the example of FIG. 2, mobile UE(s), e.g., UE1, are running an XR application 205 that may require connectivity with strict QoS to an XR server 210. As opposed to static scenarios, where possible “tracks” (and therefore “subtracks”) do not change due to mobility, mobility scenarios pose additional complexity that has not been tackled yet.

Control plane solutions need to cope with mobility, e.g., by proactively preparing the network for the change of point of attachment of the UE, and the impact that this has in terms of new subtracks used for the traffic. This requires inter-PSE coordination for the preparation of the handover. L2-specific extensions can be used to aid the UE determine where to roam to if stringent conditions need to be maintained (e.g., requiring RAW support).

The IETF DETNET and RAW WGs are responsible for the definition of data and control plane mechanisms to support deterministic networking in wired and wireless multi-hop networks. However, current solutions are limited to static scenarios, where neither the UEs nor the internal and/or local network nodes move.

Example embodiments discussed herein may provide at least solutions to solve the UE mobility problem in single domain RAW networks. For example, certain embodiments may address what a UE may need to signal to a single-domain RAW transport network about an imminent handover and convey its QoS requirements to be maintained during and after the move to another PSE. In addition, some embodiments may address what a mobile network may need to signal to single-domain RAW transport network about an imminent handover and convey its QoS requirements to be maintained during and after the move to another PSE. Further, some embodiments may address what messages might need to be exchanged among RAW nodes (e.g., PSEs) to prepare and coordinate an imminent UE handover, so that application QoS can be maintained.

Certain embodiments of the present disclosure may define and/or provide new RAW specific UE-PSE and inter-PSE interactions. These interactions may enable a UE to move within a RAW domain while maintaining the required QoS of the flow(s) of the UE. These interactions may be aimed at (i) enabling the network to react prior to UE mobility, e.g., by computing the tracks and subtracks required by the UE at its future location, and/or (ii) supporting temporal bicasting while the L2 handover takes place, e.g., to maximize resilience.

As will be discussed in more detail in the following, an embodiment may provide RAW control plane solutions to cope with terminal mobility, for example, by proactively preparing the RAW network for the change of point of attachment of the terminal. Some embodiments may provide inter-PSE coordination signaling for the preparation of the handover; both terminal and network-controlled approaches are provided. A further embodiment may provide mobile IPv6 extensions implementing the above-noted control plane solutions. Additionally, certain embodiments may provide L2-specific extensions to aid the terminal or UE to determine where to roam to if stringent conditions need to be maintained (e.g., requiring RAW support).

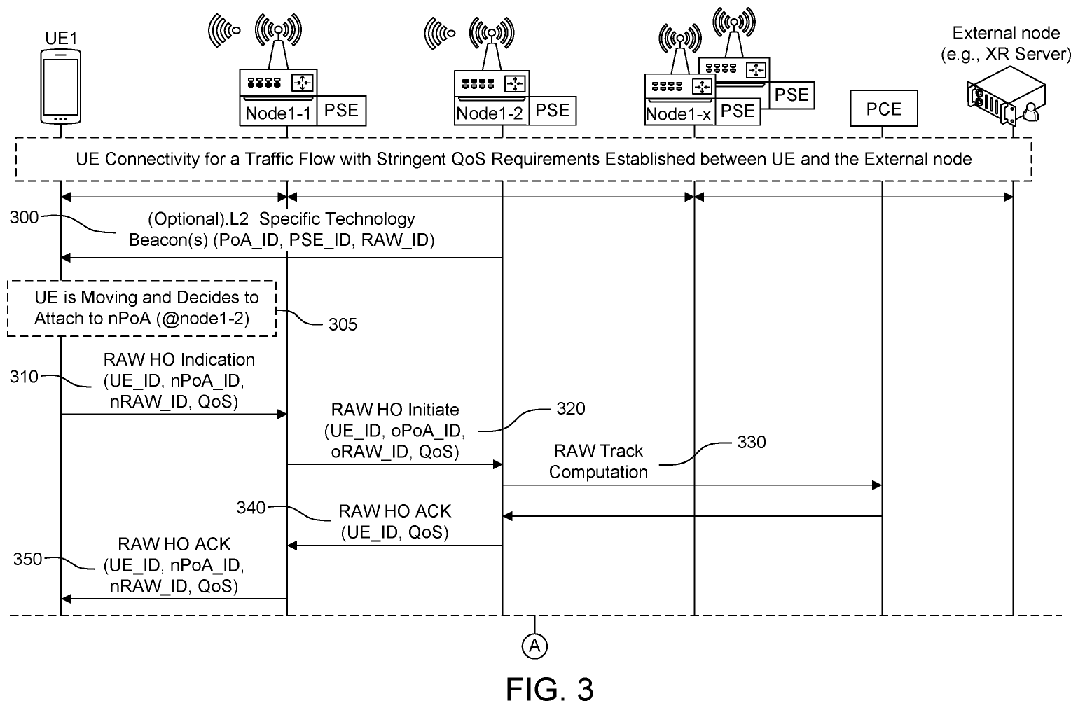

As introduced above, certain example embodiments may provide and/or configure RAW control plane extensions for UE mobility. FIG. 3 illustrates an example diagram depicting control plane signaling for UE-controlled RAW enabled mobility, according to some embodiments.

The example of FIG. 3 depicts an example of operation and signaling where a UE moves from one Point of Attachment (PoA) within a RAW domain (node1-1) to another PoA (node1-2). Signaling extensions between the UE and the RAW domain, and inter-PSE, are shown in FIG. 3. In this example, it may be assumed that the UE is running an XR application demanding stringent QoS, thus requiring from DETNET/RAW solutions. This generates a flow between the UE and an external node, in this example an XR server. However, the external node may be other types of nodes or servers. In this example, a single RAW domain is considered; however, multiple RAW domains may be contemplated. It may be assumed that the mechanisms to set-up this flow have already taken place.

As illustrated in the example of FIG. 3, at 300, optionally, the different PoAs of the RAW domain might advertise, e.g., using L2 extensions, RAW-specific information. This information might be obtained for example using the IEEE 802.11 neighbor report extensions discussed above, or by other mechanisms. This information could aid the UE to decide whether to move and where (e.g., taking into account local policies and the advertised capabilities of each available PoA). Some example, non-limited, information elements (IEs) that these advertisements (e.g., beacons) might include, per available PoA in the region, are: PoA_ID, PSE_ID, and/or RAW_ID. PoA_ID is a unique identifier (within the RAW domain) of the PoA. The PoA_ID might have the form of L2/L3 address or any other identifier (ID). The PSE_ID is unique identifier (within the RAW domain) of the PSE associated with the PoA. In most cases, there may be a PSE instance collocated with every RAW node. It might have the form of L2/L3 address or any other ID. The RAW_ID is a unique identifier of the RAW domain. As an example of technology for conveying these advertisements, the IEEE 802.11 neighbor report can be used.

In the example of FIG. 3, at 305, the UE may detect or decide (e.g., depending on whether only pure radio conditions or also other factors are considered) that a handover (HO) is imminent and, at 310, may send a message (e.g., RAW HO indication) to the network, e.g., to its current PoA. In certain embodiments, this message may include one or more of the following:
UE_ID: an identifier of the UE;
nPoA_ID: the identifier of the new PoA to which the UE is most likely to attach to. It might have the form of L2/L3 address or any other ID;
nRAW_ID: unique identifier of the RAW domain the nPoA belongs to. Certain embodiments may address the case of mobility within the same RAW domain;
QoS: a description of the QoS parameters demanded by the flow. It might be a set of one of several parameters, such as: latency, resiliency, throughput, etc.; and/or
Bicasting requested (Y/N): whether the UE requests bicasting of traffic during the handover for extra resilience. If not requested, the network can still perform it as deemed necessary to grant the required QoS.

It is noted that some of these parameters might have been learned through the optional beacons mentioned in step 300, or by any other means. It is further noted that the beacons can also be used to help the UE filtering or ranking potential target PoAs, e.g., based on their support of RAW and the domain they belong to.

As illustrated in the example of FIG. 3, at 320, the current PoA (e.g., node 1-1) may send a RAW handover initiate (e.g., RAW_HO_initiate) message to the target new PoA (e.g., node 1-2). In this embodiment, it may be considered that the UE is the entity making the PoA selection. The selection process can be considered to be performed using radio measurements, required throughput from the UE side, available throughput from the RAW node side, etc. Hence, the UE may also indicate the target PoA in the message sent at 320. In certain embodiments, this message may include one or more of the following:
UE_ID: an identifier of the UE that is about to perform a handover;
oPoA_ID: the identifier of the current (old) PoA to which the UE is currently attached to. It might have the form of L2/L3 address or any other ID;
ORAW_ID: unique identifier of the RAW domain the oPoA belongs to. Certain embodiments may address the case of mobility within the same RAW domain; and/or
QoS: a description of the QoS parameters demanded by the flow. It might be a set of one of several parameters, such as: latency, resiliency, throughput, etc.

It is noted that the new PoA (nPoA) can generally be obtained from the message sent by the UE at 310, but if the UE does not provide that information, the network may perform a selection based on the QoS demanded, the current location of the UE and/or additional information the network might have. In that case, the target nPoA (e.g., node 1-2) can be communicated to the UE in the message sent at 350.

In the example of FIG. 3, at 330, based on the information provided in the message it received at 320, the nPoA may compute the tracks and subtracks required to support the QoS of the flow, by using RAW mechanisms.

As illustrated in the example of FIG. 3, at 340, the nPoA may send an acknowledgement message (e.g., RAW_HO_ACK) to the old PoA (e.g., node 1-1). In certain embodiments, this acknowledgement message may include one or more of the following:
UE_ID: an identifier of the UE that is about to perform a handover; and/or
QoS: a description of the QoS parameters that can be granted to the flow. It might be a set of one of several parameters, such as: latency, resiliency, throughput, etc. Note that it might be equal or lower than the QoS requested at 320.

For example, according to some embodiments, if it is not possible to support the required QoS, the nPoA can propose a lower QoS in the acknowledgement message sent at 340.

In the example of FIG. 3, at 350, the old PoA (oPoA) may send a command message (e.g., RAW HO ACK) to the UE, indicating that the UE can now perform the L2 handover, and providing the granted QoS and the target PoA. According to some embodiments, at 360, substantially in parallel to the message sent at 350, and as an optional feature decided by the network, a bicasting procedure can be initiated so downlink (DL) traffic received by the oPoA are duplicated and sent to the nPoA, to minimize packet losses during the actual L2 handover. This bicasting procedure can be implemented by using the Packet Replication, Elimination, and Ordering Functions (PREOF) defined by IETF DETNET.

As illustrated in the example of FIG. 3, at 365, the UE may perform the L2 handover to attach to the nPoA (e.g., node 1-2). Upon UE attachment detection by the nPoA, RAW mechanisms may be used to activate the subtracks required for the UE's flow at its new location. As illustrated at 370, RAW signaling may be used to set-up the new forwarding status and/or to use the new subtracks. Optionally, as shown at 380, once all the required RAW forwarding state is in place, bicasting can be stopped in case this feature was initiated.

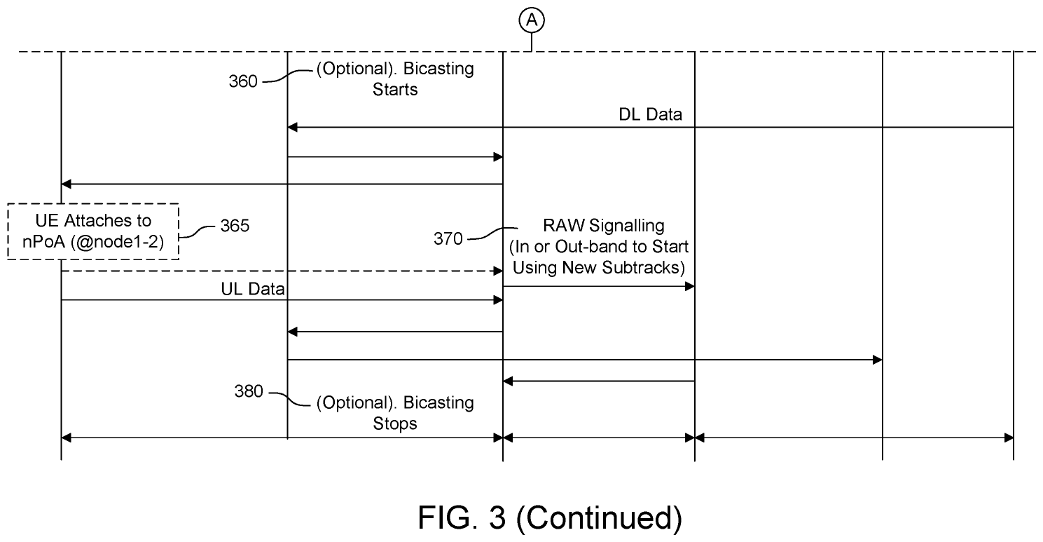

FIG. 4 illustrates an example diagram depicting control plane signaling for network-controlled RAW enabled mobility, according to some embodiments. More specifically, FIG. 4 depicts an example operation and signaling where a UE moves from one PoA within a RAW domain (e.g., node1-1) to another PoA (e.g., node1-2). In the example of FIG. 4, the mobility may be detected and handled by the network, with low (or no) involvement from the UE (as is for example the case in 3GPP-based networks). In this example, it may again be assumed that the UE is running an XR application demanding stringent QoS, thus requiring from DETNET/RAW solutions. This generates a flow between the UE and an external node, in this example an XR server. However, other examples are also possible according to certain embodiments. In this example, a single RAW domain is considered. However, multiple RAW domains may be contemplated according to other embodiments. It may be assumed that the mechanisms to set-up this flow have already taken place.

As illustrated in the example of FIG. 4, UE connectivity for a traffic flow with stringent QoS requirements is established between the UE and the external node. In the example of FIG. 4, at 405, the UE may be about to move, e.g., a handover is imminent to a new PoA. This imminent handover may be decided by the UE, or may be triggered or commanded by the network. In this example, the network may be in control, e.g., by using 3GPP available reports and knowledge of the UE location. As illustrated at 410, the network may initiate the process by sending a message (e.g., RAW HO indication) to the current PoA (oPoA, e.g., node 1-1). As used herein, the term “network” is intended to be as general as possible and not exclude any possible option, but examples of network entities that may send the message at 410 may include an access and mobility management function (AMF), gNB, user plane function (UPF), IEEE 802.11 Access Point, or the like. In an embodiment, this message (e.g., RAW HO indication) may include one or more of the following:
UE_ID: an identifier of the UE;
nPoA_ID: the identifier of the new PoA to which the UE is most likely to attach to. It might have the form of L2/L3 address or any other ID;
nRAW_ID: unique identifier of the RAW domain the nPoA belongs to. It is only in the scope of this disclosure the case of mobility within the same RAW domain;
QoS: a description of the QoS parameters demanded by the flow. It might be a set of one of several parameters, such as: latency, resiliency, throughput, etc.; and/or
Bicasting requested (Y/N): whether the UE requests bicasting of traffic during the handover for extra resilience. If not requested, the network can still perform it as deemed necessary to grant the required QoS.

In the example of FIG. 4, at 415, the network may trigger the signaling that follows. At 420, the current PoA (e.g., node 1-1) may send a RAW handover initiate (e.g., RAW HO initiate) message to the target new PoA (e.g., node 1-2). According to certain embodiments, this message may include one or more of the following:
UE_ID: an identifier of the UE that is about to perform a handover;
oPoA_ID: the identifier of the current (old) PoA to which the UE is currently attached to. It might have the form of L2/L3 address or any other ID;
oRAW_ID: unique identifier of the RAW domain the oPoA belongs to. Certain embodiments may address the case of mobility within the same RAW domain; and/or
QoS: a description of the QoS parameters demanded by the flow. It might be a set of one of several parameters, such as: latency, resiliency, throughput, etc.

As illustrated in the example of FIG. 4, at 430, with the information provided in the message received at 420, the nPoA (e.g., node 1-2) may compute the tracks and/or subtracks required to support the QoS of the flow, e.g., by using RAW mechanisms. At 440, the nPoA may send an acknowledgement message (e.g., RAW HO ACK) to the old PoA. According to some embodiments, the acknowledgement message may contain one or more of the following:
UE_ID: an identifier of the UE that is about to perform a handover; and/or
QoS: a description of the QoS parameters that can be granted to the flow. It might be a set of one of several parameters, such as: latency, resiliency, throughput, etc. It is noted that the granted QoS might be equal to or lower than the QoS requested in the message at 420.

In certain embodiments, if it is not possible to support the required QoS of the flow, the nPoA can propose a lower QoS when sending the message at 440.

As illustrated in the example of FIG. 4, at 450, the old PoA may send a command message (e.g., RAW HO ACK) to the UE, indicating that the UE can now perform the L2 handover, and providing an indication of the granted QoS and the target PoA. In some embodiments, substantially in parallel to the message at 450, and as an optional feature decided by the network, at 460, a bicasting procedure can be initiated so downlink (DL) traffic received by the oPoA are duplicated and also sent to the nPoA, e.g., to minimize packet losses during the actual L2 handover. This bicasting procedure can be implemented by using the Packet Replication, Elimination, and Ordering Functions (PREOF) defined by IETF DETNET.

In the example of FIG. 4, at 465, the UE may perform the L2 handover and attach to the nPoA (e.g., node 1-2). Upon UE attachment detection by the nPoA, RAW mechanisms may be used to activate the subtracks required for the UE's flow at its new location. At 470, RAW signaling may be used to set-up the new forwarding status and/or subtracks. Once the required RAW forwarding state is in place, at 480, bicasting can be stopped in case this feature was initiated.

The control plane extensions introduced in the foregoing can be implemented over different protocols. For example, certain embodiments may provide or specify extensions to Proxy Mobile IPv6 and Fast Handovers for Proxy Mobile IPv6. In some embodiments, the RAW HO Initiate and RAW HO ACK messages can be implemented by extending Handover Initiate (HI) and Handover Acknowledgement mobility headers RFC 5568 [4], RFC 5949 [5].

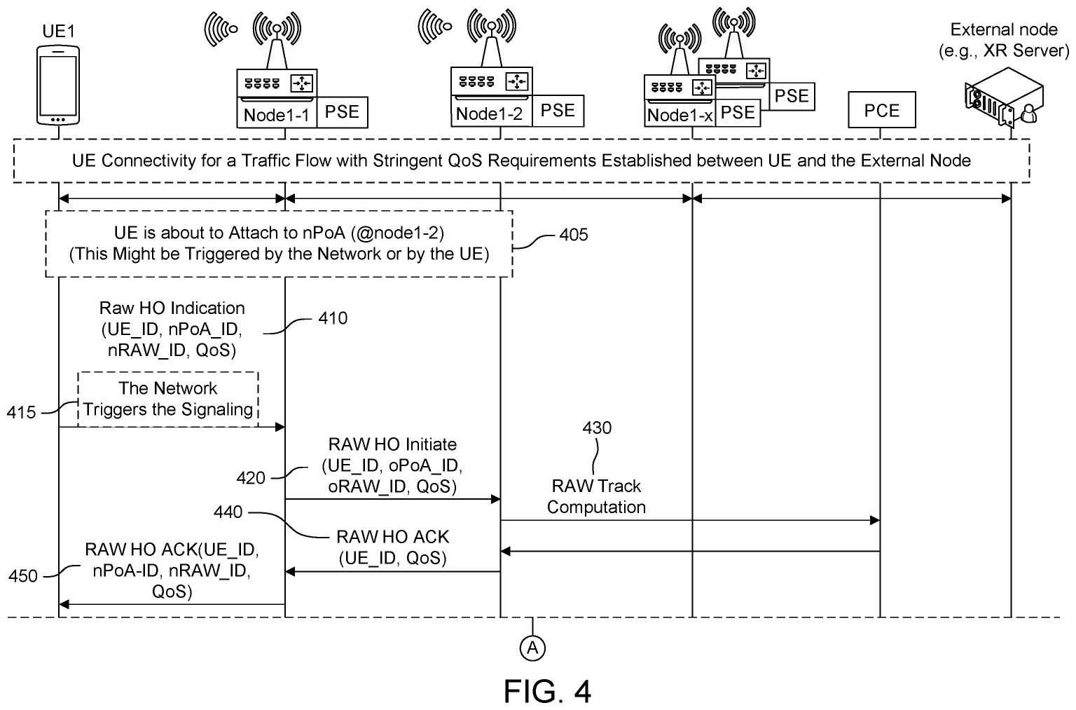

Certain embodiments may provide or configure extensions to the HI message in RFC 5568 and RFC 5949. FIG. 5 illustrates an example of the format of the message data field in the Mobility Header, according to an embodiment. The IP Fields may include a Source Address (e.g., the IP address of the oPoA) and/or a Destination Address (e.g., the IP address of the nPoA). The Message Data may include one or more of the following: Sequence # (e.g., may be the same as defined in RFC 5568), ‘S’ flag (e.g., as defined in RFC 5568, and set to zero in this embodiment), ‘U’ flag (e.g., buffer flag, which may be the same as defined in RFC 5568), ‘P’ flag (e.g., proxy flag that is used to distinguish the message from that defined in RFC 5568, and is set), ‘F’ flag (e.g., forwarding flag that is used to request to setup bicasting for this flow), Reserved (e.g., may be same as defined in RFC 5568), and Code (e.g., where RFC 5568 defines this field and its values, 0 and 1. Code is set to zero according to certain embodiments). The Mobility options field may contain one or more mobility options, whose encoding and formats are defined in RFC 6275 [6].

To uniquely identify the target UE, the UE identifier is contained in the Mobile Node Identifier option. This option can be used to carry the UE_ID parameter described herein with respect to certain embodiments. According to some embodiments, one or more of the following new options (as discussed in the foregoing) can be used in the extended HI message of FIG. 5: RAW_ID, PoA_ID, and/or QoS.

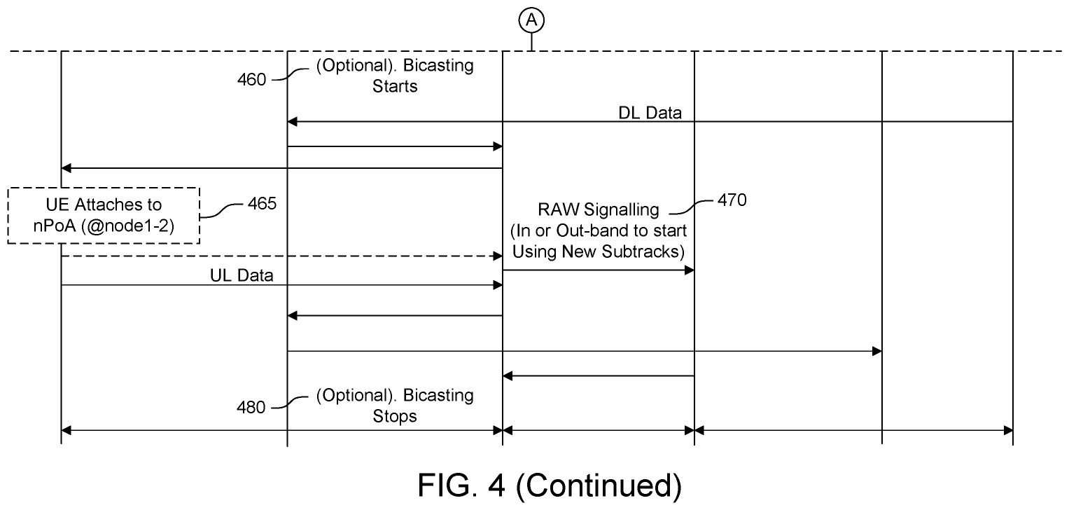

Certain embodiments may configure or define extensions to the handover acknowledgement (Hack) message in RFC 5568. FIG. 6 shows an example of the format of the Message Data field in the Mobility Header, according to some embodiments. The IP Fields may include a Source Address (e.g., copied from the destination address of the Handover Initiate message to which this message is a response) and/or a Destination Address (e.g., copied from the source address of the Handover Initiate message to which this message is a response). For the Message Data, the usage of Sequence # and Reserved fields may be the same as those in RFC 5568. The Message Data may also include: ‘U’ flag (e.g., buffer flag that may be same as defined in RFC 5568), ‘P’ flag (e.g., proxy flag that may be used to distinguish the message from that defined in defined RFC 5568, and is set), ‘F’ flag (e.g., forwarding flag that may be used to request to setup bicasting for this flow), Reserved (e.g., same as defined in RFC 5568), and Code (e.g., RFC 5568 defines this field and its values, 0 (Handover Accepted or Successful) to 4 and 128 to 130. Values 131 and 132 are defined in RFC 5949). For RAW mobility purposes the following new values for the Code field are defined: 133 indicating that it is not possible to grant requested QoS, and/or a lower QoS proposed. The Mobility options field contains one or more mobility options, whose encoding and formats are defined in RFC 6275. The mobility option that uniquely identifies the target mobile node is copied from the corresponding RAW HO Initiate message. In some embodiments, the following new options can be used in this message: RAW_ID, PoA_ID, and/or RAW QoS.

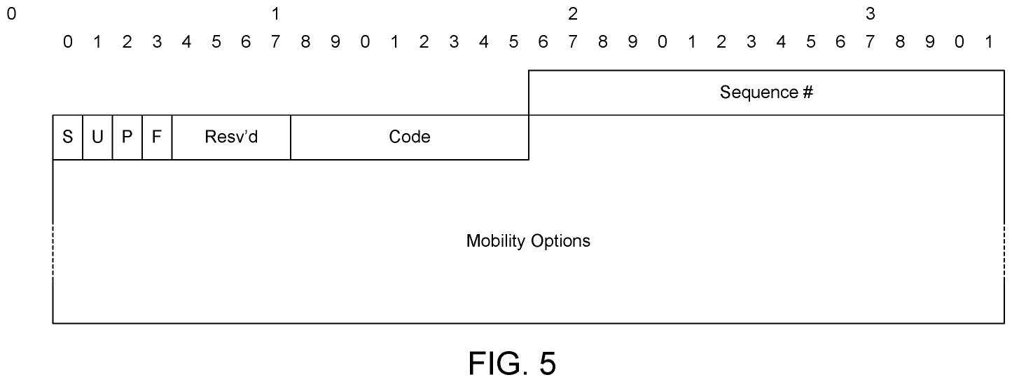

Certain example embodiments may provide or configure new mobility options. FIG. 7 illustrates an example format of a RAW_ID mobility option, according to some embodiments. As illustrated in the example of FIG. 7, the RAW_ID mobility option may include an Option Type field, an Option Length field, a RAW ID Length field, a RAW ID field, and a Reserved field. In an example embodiment, the Option Length may be 8-bit unsigned integer (e.g., length of the option, in octets, excluding the Option Type and Option Length fields), RAW ID Length may be 8-bit unsigned integer (e.g., length of the RAW ID field, in octets), and RAW ID may be a variable length field that identifies the RAW domain.

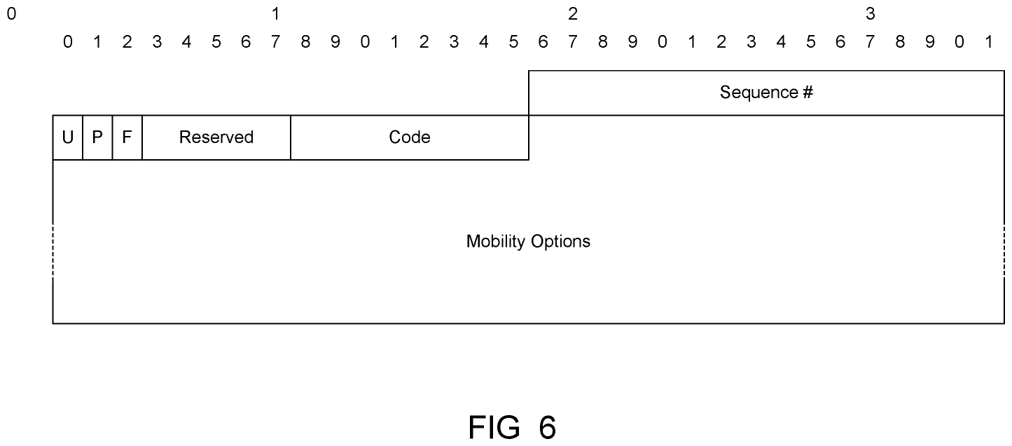

FIG. 8 illustrates an example format of a PoA_ID mobility option, according to some embodiments. As illustrated in the example of FIG. 8, the PoA_ID mobility option may include an Option Type field, an Option Length field, a PoA ID Length field, a PoA ID Format field, and a PoA ID field. In an example embodiment, the Option Length may be 8-bit unsigned integer (e.g., length of the option, in octets, excluding the Option Type and Option Length fields), PoA ID Length may be 8-bit unsigned integer (e.g., Length of the PoA ID field, in octets), PoA ID Format may be 8-bit unsigned integer (e.g., which identifies the format of the PoA ID. Possible values may be 0 (Reserved), 1 (IP address—v4 or v6, determined by PoA ID Length), 2 (L2 address—48 or 64 bit, determined by PoA ID Length), 3 (URI) and 4-255 (reserved for future use)), and PoA ID (e.g., variable length field that identifies the PoA).

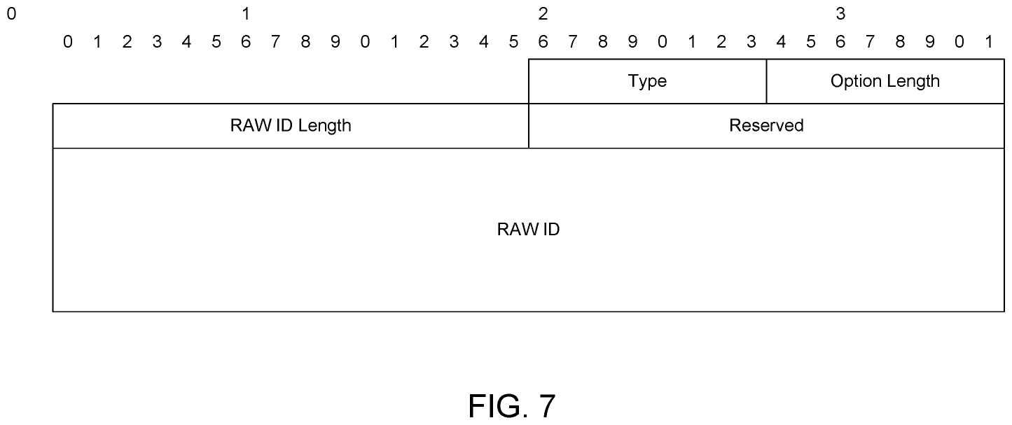

FIG. 9 illustrates an example format for a RAW QoS mobility option, according to an embodiment. As depicted in the example of FIG. 9, the RAW QoS mobility option may include an Option Type field, an Option Length field, a minimum bandwidth (MinBandwidth) field, a maximum latency (MaxLatency) field, a maximum latency variation (MaxLatency Variation) field, a maximum loss (MaxLoss) field, a maximum consecutive loss tolerance (MaxConsecutiveLossTolerance) field, and a maximum misordering (MaxMisordering) field. In an example embodiment, the Option Length may be an 8-bit unsigned integer (e.g., length of the option in octets, excluding the Option Type and Option Length fields, which may be set to 24), MinBandwidth may be 32-bit unsigned integer (e.g., MinBandwidth is the minimum bandwidth that has to be guaranteed for the flow. MinBandwidth is specified in octets per second), MaxLatency may be 32-bit unsigned integer (e.g., MaxLatency is the maximum latency from Ingress to Egress(es) for a single packet of the flow. MaxLatency is specified as an integer number of nanoseconds), MaxLatency Variation may be 32-bit unsigned integer (e.g., MaxLatency Variation is the difference between the minimum and the maximum end-to-end, one-way latency. MaxLatency Variation is specified as an integer number of nanoseconds), MaxLoss may be 32-bit unsigned integer (e.g., MaxLoss defines the maximum Packet Loss Rate (PLR) requirement for the flow between the Ingress and Egress(es) and the loss measurement interval), MaxConsecutiveLossTolerance may be 32-bit unsigned integer (e.g., some applications have special loss requirements, such as MaxConsecutiveLossTolerance. The maximum consecutive loss tolerance parameter describes the maximum number of consecutive packets whose loss can be tolerated. The maximum consecutive loss tolerance can be measured, for example, based on sequence number), and MaxMisordering may be 32-bit unsigned integer (e.g., MaxMisordering describes the tolerable maximum number of packets that can be received out of order. The value zero for the maximum allowed misordering indicates that in-order delivery is required; misordering cannot be tolerated. The maximum allowed misordering can be measured, for example, based on sequence numbers. When a packet arrives at the egress after a packet with a higher sequence number, the difference between the sequence number values cannot be bigger than “MaxMisordering+1”).

Certain embodiments may provide or configure a method for extending the Neighbor report. As an example, L2-specific solution to advertise RAW capabilities to roaming UEs, this method may extend the Neighbor report by adding new subelements to the NeighborListSet defined in Section 9.4.2.37 of IEEE 802.11-2016 standard. According to certain embodiments, the subelements may include a PoA ID subelement, a PSE ID subelement, and a RAW ID subelement.

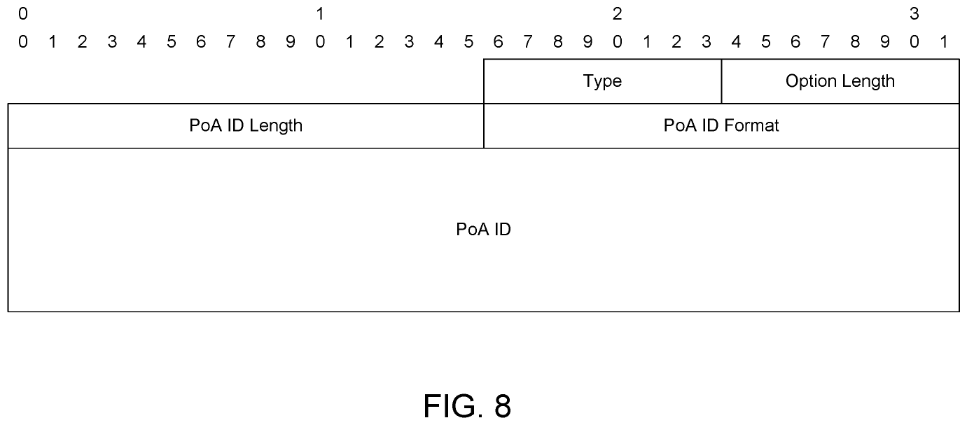

FIG. 10 illustrates an example of a PoA ID subelement, according to an embodiment. As shown in the example of FIG. 10, the PoA ID subelement may include a Subelement ID that is to be assigned by IEEE, a length field indicating the length of the PoA ID, and a PoA ID field indicating the ID of the PoA.

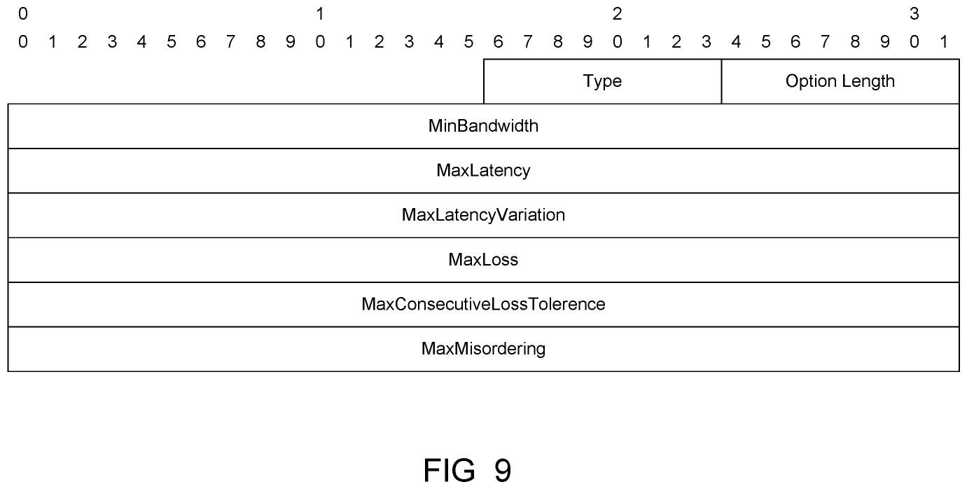

FIG. 11 illustrates an example of a PSE ID subelement, according to an embodiment. As shown in the example of FIG. 11, the PSE ID subelement may include a Subelement ID that is to be assigned by IEEE, a length field indicating the length of the PSE ID, and a PSE ID field indicating the ID of the PSE.

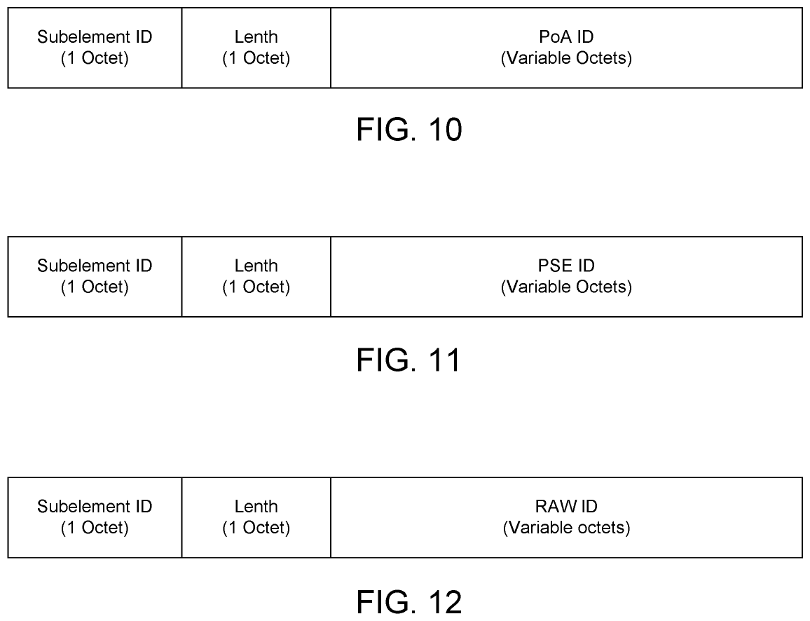

FIG. 12 illustrates an example of a RAW ID subelement, according to an embodiment. As shown in the example of FIG. 12, the RAW ID subelement may include a Subelement ID that is to be assigned by IEEE, a length field indicating the length of the RAW ID, and a RAW ID field indicating the ID of the RAW domain.

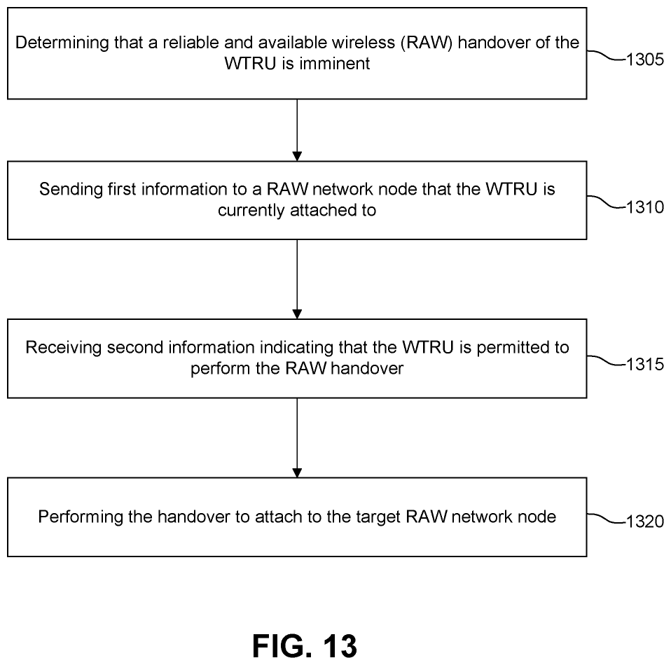

FIG. 13 is an example flow diagram illustrating an example method of enabling, supporting and/or improving terminal mobility in reliable and available wireless (RAW) networks, according to some example embodiments. The example method of FIG. 13 and accompanying disclosures herein may be considered a generalization or synthetization of the various disclosures discussed above. For convenience and simplicity of exposition, the example of FIG. 13 may be described with reference to the architecture or system described above with respect to FIGS. 1A-1D and/or FIG. 2, for instance. However, the example method depicted in FIG. 13 may be carried out using different architectures as well. According to some embodiments, the method of FIG. 13 may be implemented by a UE or WTRU, such as the WTRU 102 described in the foregoing. For instance, in one embodiment, the method of FIG. 13 may be implemented by UE1 as illustrated in FIGS. 2, 3, and/or 4 and discussed above. As such, the method of FIG. 13 may be modified to include any of the steps, procedures and/or details illustrated in the examples of FIG. 2, FIG. 3, and/or FIG. 4. Moreover, it is noted that the method and/or blocks of FIG. 13 may be modified to include, or to be replaced by, any one or more of the procedures or blocks discussed elsewhere herein. As such, one of ordinary skill in the art would understand that FIG. 13 is provided as one example and modifications thereto are possible while remaining within the scope of certain example embodiments.

As illustrated in the example of FIG. 13, the method may include, at 1305, determining that a reliable and available wireless (RAW) handover of the WTRU is imminent. For example, a RAW handover of the WTRU may be imminent if it is set to occur (e.g., about to occur), for example, within a certain time period or threshold, e.g., which may be determined based on radio conditions, mobility, and/or other factors.

In some example embodiments, based on the determination that the RAW handover of the WTRU is imminent, the method may include, at 1310, sending first information to a RAW network node that the WTRU is currently attached to. For example, the first information may include and/or may indicate one or more of: (i) quality of service (QoS) parameters required during and after the RAW handover by a flow between the WTRU and an external node, (ii) whether bicasting is requested, and/or (iii) any of: an identifier of the WTRU, an identifier of a target RAW network node that the WTRU wants to attach to, and/or an identifier of a RAW domain that the target RAW network node belongs to. According to some examples, the RAW network node currently serving the WTRU and/or the target RAW network node may be or may include a point of attachment (PoA) within the RAW domain. In certain example embodiments, the QoS parameters may be or may include one or more of latency, resiliency, and/or throughput parameters.

According to an example embodiment, as illustrated in the example of FIG. 13, the method may include, at 1315, receiving second information indicating that the WTRU is permitted to perform (e.g., can perform or is allowed to perform) the RAW handover. In one example, the second information may include an indication of a granted QoS for the flow and the identifier of the target RAW network node that the WTRU should attach to. As shown in the example of FIG. 13, the method may include, at 1320, performing the handover to attach to the target RAW network node.

In certain example embodiments, although not illustrated in the example of FIG. 13, the method may optionally include receiving RAW-specific information to assist the WTRU in determining that the handover is imminent and/or to assist in determining the target RAW network node that the WTRU wants to attach to. According to some examples, the RAW-specific information comprises any of: a point of attachment (PoA) identifier, an identifier of a path selection engine (PSE) associated with the point of attachment (PoA), and/or an identifier of the RAW domain.

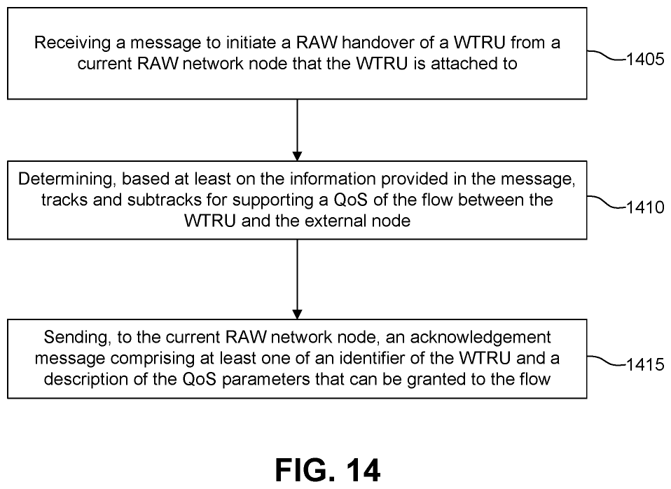

FIG. 14 is an example flow diagram illustrating an example method of enabling, supporting and/or improving terminal mobility in reliable and available wireless (RAW) networks, according to some example embodiments. The example method of FIG. 14 and accompanying disclosures herein may be considered a generalization or synthetization of the various disclosures discussed above. For convenience and simplicity of exposition, the example of FIG. 14 may be described with reference to the architecture or system described above with respect to FIGS. 1A-1D and/or FIG. 2, for instance. However, the example method depicted in FIG. 14 may be carried out using different architectures as well. According to some embodiments, the method of FIG. 14 may be implemented by a network node or element, such as target RAW network node described in the foregoing. For instance, in one embodiment, the method of FIG. 14 may be implemented by node 1-2 as illustrated in FIGS. 2, 3, and/or 4 and discussed above. As such, the method of FIG. 14 may be modified to include any of the steps, procedures and/or details illustrated in the examples of FIG. 2, FIG. 3, and/or FIG. 4. Moreover, it is noted that the method and/or blocks of FIG. 14 may be modified to include, or to be replaced by, any one or more of the procedures or blocks discussed elsewhere herein. As such, one of ordinary skill in the art would understand that FIG. 14 is provided as one example and modifications thereto are possible while remaining within the scope of certain example embodiments.

As illustrated in the example of FIG. 14, the method may include, at 1405, receiving a message to initiate a RAW handover of a WTRU from a current RAW network node that the WTRU is attached to. In an embodiment, the message may be received from the current RAW network node, and the message may include or may indicate information including any one or more of: an identifier of the WTRU, an identifier of the current RAW network node that the WTRU is attached to, an identifier of a RAW domain that the current RAW network node belongs to, and/or a description of quality of service (QoS) parameters required by a flow between the WTRU and an external node. In one example embodiment, the target RAW network node and/or the current RAW network node may be or may include a point of attachment (PoA) within the RAW domain.

According to an embodiment, as illustrated in the example of FIG. 14, the method may include, at 1410, determining, based at least on the information provided in the message, tracks and subtracks for supporting a QoS of the flow between the WTRU and the external node. In an embodiment, the method may include, as illustrated at 1415, sending, to the current RAW network node, an acknowledgement message that may include or may indicate at least one of an identifier of the WTRU and a description of the QoS parameters that can be granted to the flow.

In an example embodiment, on condition that a bicasting procedure is initiated, the method may include receiving duplicated traffic from the WTRU. In an example embodiment, upon detecting attachment of the WTRU, the method may include activating the subtracks for supporting the flow using RAW mechanisms.

In an example embodiment, on condition that it is not possible to support the QoS parameters required by the flow, the QoS parameters granted to the flow are lower than the QoS parameters required by the flow. According to one example, the QoS parameters may include one or more of latency, resiliency, and/or throughput parameters.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

### REFERENCES

[1] C J. Bernardos (Ed.), “RAW use cases,” RFC 9450 August 2023.
[2] P. Thubert (Ed.), “Reliable and Available Wireless Architecture/Framework,” draft-ietf-raw-architecture-04, March 2022.
[3] F. Theoleyre, et al., “Operations, Administration and Maintenance (OAM) features for RAW”, draft-ietf-raw-oam-support-04, February 2022.
[4] R. Koodli (Ed.), “Mobile IPv6 fast handovers” RFC 5568. 2009.
[5] H. Yokota, et al., “Fast handovers for proxy mobile IPv6”, RFC 5949. 2010.
[6] C. Perkins (Ed.), “Mobility Support in IPv6”, RFC 6275, 2011.

1. A method, implemented by a wireless transmit/receive unit (WTRU), the method comprising:
determining that a reliable and available wireless (RAW) handover of the WTRU is going to occur;
based on the determination that the RAW handover of the WTRU is going to occur, sending first information to a RAW network node that the WTRU is currently attached to, wherein the first information indicates (i) quality of service (QoS) parameters required during and after the RAW handover by a flow between the WTRU and an external node, (ii) whether bicasting is requested, and (iii) any of: an identifier of the WTRU, an identifier of a target RAW network node that the WTRU wants to attach to, and an identifier of a RAW domain that the target RAW network node belongs to;
receiving second information indicating that the WTRU is permitted to perform the RAW handover, wherein the second information comprises an indication of a granted QoS for the flow and the identifier of the target RAW network node that the WTRU should attach to; and
performing the handover to attach to the target RAW network node.

2. The method of claim 1, comprising:
receiving RAW-specific information to assist the WTRU in determining any of (1) that the handover is going to occur and (2) the target RAW network node that the WTRU wants to attach to.

3. The method of claim 2, wherein the RAW-specific information comprises any of: a point of attachment (PoA) identifier, an identifier of a path selection engine (PSE) associated with the point of attachment (PoA), and an identifier of the RAW domain.

4. The method of claim 1, wherein the QoS parameters comprise RAW augmented parameters including any of bounded latency, jitter, reliability and availability.

5. The method of claim 1, wherein the QoS parameters comprise any of latency, resiliency, and throughput parameters.

6. The method of claim 1, wherein any of the RAW network node currently serving the WTRU and/or the target RAW network node comprise a point of attachment (PoA) within the RAW domain.

7. A wireless transmit/receive unit (WTRU), comprising:
circuitry, including any of a transmitter, receiver, processor and memory, the circuitry configured to:
determine that a reliable and available wireless (RAW) handover of the WTRU is going to occur;
based on the determination that the RAW handover of the WTRU is going to occur, send first information to a RAW network node that the WTRU is currently attached to, wherein the first information indicates (i) quality of service (QoS) parameters required during and after the RAW handover by a flow between the WTRU and an external node, (ii) whether bicasting is requested, and (iii) any of: an identifier of the WTRU, an identifier of a target RAW network node that the WTRU wants to attach to, and an identifier of a RAW domain that the target RAW network node belongs to;
receive second information indicating that the WTRU is permitted to perform the RAW handover, wherein the second information comprises an indication of a granted QoS for the flow and the identifier of the target RAW network node that the WTRU should attach to; and
perform the handover to attach to the target RAW network node.

8. The WTRU of claim 7, wherein the circuitry is configured to:
receive RAW-specific information to assist the WTRU in determining any of (1) that the handover is going to occur and (2) the target RAW network node that the WTRU wants to attach to.

9. The WTRU of claim 8, wherein the RAW-specific information comprises any of: a point of attachment (PoA) identifier, an identifier of a path selection engine (PSE) associated with the point of attachment (PoA), and an identifier of the RAW domain.

10. The WTRU of claim 7, wherein the QoS parameters comprise RAW augmented parameters including any of bounded latency, jitter, reliability and availability.

11. The WTRU of claim 7, wherein the QoS parameters comprise any of latency, resiliency, and throughput parameters.

12. The WTRU of claim 7, wherein any of the RAW network node currently serving the WTRU and the target RAW network node comprise a point of attachment (PoA) within the RAW domain.

13. (canceled)

14. (canceled)

15. (canceled)

16. (canceled)

17. (canceled)

18. (canceled)

19. (canceled)

20. An apparatus, comprising:
circuitry, including any of a transmitter, receiver, processor and memory, the circuitry configured to:
receive a message to initiate a RAW handover of a wireless transmit/receive unit (WTRU) from a current RAW network node to which the WTRU is attached to the apparatus,
wherein the message comprises information including any of: an identifier of the WTRU, an identifier of the current RAW network node that the WTRU is attached to, an identifier of a RAW domain that the current RAW network node belongs to, and a description of quality of service (QoS) parameters required by a flow between the WTRU and an external node;
determine, based at least on the information provided in the message, tracks and subtracks for supporting a QoS of the flow between the WTRU and the external node; and
send, to the current RAW network node, an acknowledgement message comprising any of an identifier of the WTRU and a description of the QoS parameters that can be granted to the flow.

21. The apparatus of claim 20, wherein, on condition that a bicasting procedure is initiated, the circuitry is configured to receive duplicated traffic from the WTRU.

22. The apparatus of claim 20, wherein the circuitry is configured to:
upon detecting attachment of the WTRU, activate the subtracks for supporting the flow using RAW mechanisms.

23. The apparatus of claim 20, wherein, on condition that it is not possible to support the QoS parameters required by the flow, the QoS parameters granted to the flow are lower than the QoS parameters required by the flow.

24. The apparatus of claim 20, wherein the QoS parameters comprise RAW augmented parameters including any of bounded latency, jitter, reliability and availability.

25. The apparatus of claim 20, wherein the QoS parameters comprise any of latency, resiliency, and throughput parameters.

26. The apparatus of claim 20, wherein any of the apparatus and the current RAW network node comprise a point of attachment (PoA) within the RAW domain.
